(19) United States
(12) Patent Application Publication
(10) Pub. No.: US 2019/0210509 A1
(43) Pub. Date: Jul. 11, 2019

(54) Truck Box Cable Lock Assembly

(71) Applicant: Ford Global Technologies, LLC, Dearborn, MI (US)

(72) Inventors: Joshua Robert Hemphill, White Lake, MI (US); Jack Marchlewski, Saline, MI (US); Dragan B. Stojkovic, Taylor, MI (US); Jeffrey Gray, Dearborn, MI (US); Robert Reiners, Grosse Ile, MI (US)

(73) Assignee: Ford Global Technologies, LLC, Dearborn, MI (US)

(21) Appl. No.: 15/865,330

(22) Filed: Jan. 9, 2018

(51) Int. Cl. B60P 7/08; E05B 73/00

(52) U.S. Cl. CPC B60P 7/0846; E05B 73/0011; B60P 7/0807

(57) ABSTRACT

A truck box cable assembly including a first standard interface plate (“SIP”), a reel assembly, and a second SIP is provided. The reel assembly includes a base for securing to the first SIP, a first lock portion, and a cable wound about a spool for extending and retracting. The second SIP is located on a truck box wall opposite a location of the first SIP and has a second lock portion to receive the first lock portion to selectively secure the cable. The base may include two components slidably mounted to one another to translate between a first position and a second position. Each of the two components may include a hook portion for grasping the first SIP in the first position for securing the base thereto.

### TECHNICAL FIELD

This disclosure relates to cable assemblies for securing items within a pickup truck box.

### BACKGROUND

Pickup trucks are motor vehicles with a front passenger area, often referred to as a cab, and an open top rear cargo area, often referred to as a truck box. The truck box usually has a substantially flat-bed from which two side body sidewalls and a forward interconnecting header extend upwardly from the bed. A bottom hinged door, commonly referred to as a tailgate, hinged at the rear edge of the bed and closable provides a fourth wall for the cargo area. Cabs and truck boxes may be separate assemblies or part of the same unibody structure. Pickup trucks are popular largely because the truck box allows them to be utilized in many different ways, including carrying a variety of types of cargo based on available truck box stowage volume. The cargo may be vulnerable to theft while in the truck box.

This disclosure is directed to solving the above problems and other problems as summarized below.

### SUMMARY

According to an aspect of the present disclosure, a truck box cable assembly includes a first standard interface plate (“SIP”), a reel assembly, and a second SIP. The reel assembly includes a base for securing to the first SIP, a first lock portion, and a cable wound about a spool for extending and retracting. The second SIP is located on a truck box wall opposite a location of the first SIP and has a second lock portion to receive the first lock portion to selectively secure the cable. The base may include two components slidably mounted to one another to translate between a first position and a second position. Each of the two components may include a hook portion for grasping the first SIP in the first position for securing the base thereto. The second SIP may include two base portions for securing to the truck box wall opposite a location of the first SIP and a raised portion extending therebetween such that the raised portion is spaced from the truck box wall to accommodate the first lock portion extending through a second SIP bracket aperture. The first lock portion and the second lock portion may include a tumbler and cam arranged with one another to engage and disengage with the second SIP. The reel assembly may further include a retraction knob arranged with the cable such that rotation of the retraction knob wraps the cable about the spool to stow the cable within a housing of the reel assembly. The first SIP and the second SIP may be arranged with one another for the cable to extend and lock to the second SIP such that the cable may extend through an opening of an item to secure to item within the truck box. The truck box wall may be one of a header and a sidewall.

According to another aspect of the present disclosure, a truck box assembly includes a first sidewall including a first SIP bracket, a second sidewall opposite the first sidewall and including a second SIP bracket, and a cable assembly. The cable assembly includes a support structure for securing to the first SIP bracket, a reel, and a retractable cable for winding and unwinding about the reel, and a lock mechanism for securing the retractable cable to the second SIP bracket. A retraction knob may extend from the reel to rotate the reel and retract the retractable cable there about and the retraction knob may include a retraction lock to retain the reel in a position. The support structure may include two plates slidably arranged with one another to translate between a first position and a second position in which the support structure is secured to the first SIP bracket. Each of the two plates may include a hook extending from a respective plate such that each hook grasps the first SIP bracket when the two plates are in the second position. The lock mechanism may include a tumbler and cam arranged with one another to engage and disengage the lock mechanism to the second SIP bracket. The second SIP bracket may include two base portions for securing to the second sidewall and a raised portion extending therebetween such that the raised portion is spaced from the second sidewall to accommodate a lock portion of the lock mechanism extending through a second SIP bracket aperture. The first SIP bracket and the second SIP bracket may be arranged with one another for the retractable cable to extend and lock to the second SIP bracket such that the retractable cable may extend through an opening of an item to secure the item within a truck box at least partially defined by the first sidewall and the second sidewall.

According to a further aspect of the present disclosure, a pickup truck box assembly includes a truck box and a cable assembly. The truck box includes a bed supporting a first sidewall including a first SIP bracket and a second sidewall including a second SIP bracket. The cable assembly includes a base for mounting to the first SIP bracket and a retractable cable having a lock mechanism. The retractable cable is extendable between a first position wound about a reel and a second position in which the lock mechanism is locked to the second SIP bracket. The second SIP bracket may include two base portions for securing to the second sidewall and a raised portion extending therebetween such that the raised portion is spaced from the second sidewall to accommodate a lock portion of the lock mechanism extending through a second SIP bracket aperture. The base may further include a first component slidably mounted to a second component for translation between first and second positions. Each of the first component and the second components may include a hook portion for grasping the first SIP bracket to secure the base to the first SIP bracket in the second position. The lock mechanism may include a rotatable tumbler and cam sized for insertion within an aperture of the second SIP bracket such that the cam may rotate under key to engage the lock mechanism to the second SIP bracket. The cable assembly may further include a retraction knob extending from the reel to rotate the reel and retract the retractable cable there about. The retraction knob may include a retraction lock to retain the reel in a position. One of the first sidewall and the second sidewall may be a header.

The above aspects of the disclosure and other aspects will be apparent to one of ordinary skill in the art in view of the attached drawings and the following detailed description of the illustrated embodiments.

### BRIEF DESCRIPTION OF THE DRAWINGS

FIG. 1 is a rear perspective view of an example of a portion of a pickup truck.

FIG. 2 is a rear perspective view of an example of a pickup truck box shown with an example of a cable lock assembly.

FIG. 3 is a side vie of a portion of the cable lock assembly of FIG. 2.

FIG. 4 is a front view of the portion of the cable lock assembly of FIG. 3.

FIG. 5 is a front view of a portion of the cable lock assembly of FIGS. 3, 4, and 5.

FIG. 6 is a fragmentary perspective view of a portion of the pickup truck box of FIG. 2 illustrating a portion of a cable lock assembly.

FIG. 7 is a rear view of the pickup truck box of FIG. 2 shown with items secured within the truck box via the cable lock assembly of FIG. 2.

### DETAILED DESCRIPTION

The illustrated embodiments are disclosed with reference to the drawings. However, it is to be understood that the disclosed embodiments are intended to be merely examples that may be embodied in various and alternative forms. The figures are not necessarily to scale and some features may be exaggerated or minimized to show details of particular components. The specific structural and functional details disclosed are not to be interpreted as limiting, but as a representative basis for teaching one skilled in the art how to practice the disclosed concepts.

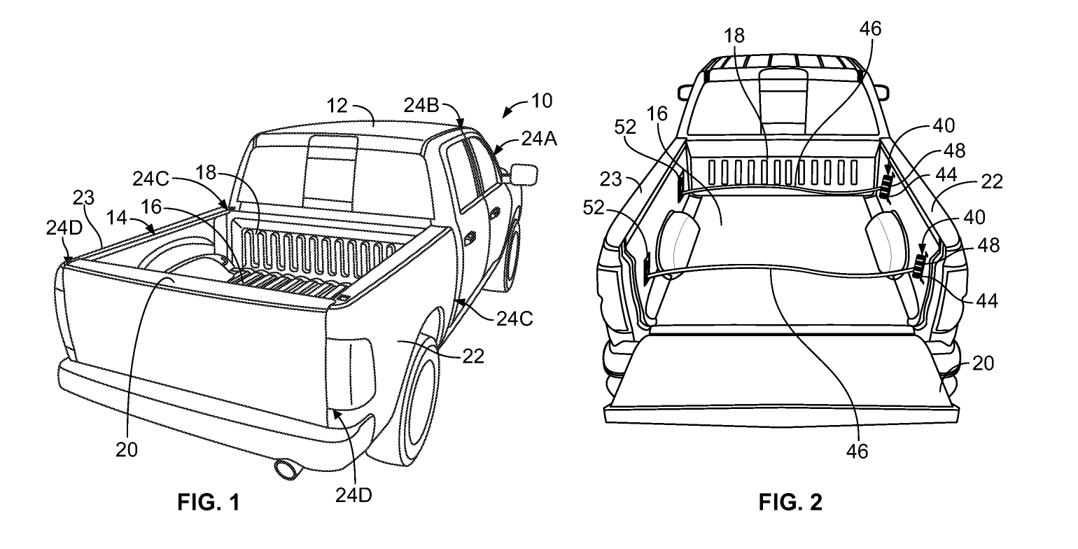

FIG. 1 illustrates an example of a vehicle 10 that includes a cabin 12 and a truck box 14 supported by a vehicle chassis (not shown). The truck box 14 includes a bed 16 having a forward end adjacent to the cabin 12 and a rear end opposite the forward end. The bed 16 supports a header 18 at the forward end and a tailgate 20 at the rear end. The tailgate 20 is pivotally mounted to the bed 16. The bed 16 further supports a first sidewall 22 and a second sidewall 23. The header 18, the tailgate 20, the first sidewall 22, and the second sidewall 23 define a truck box cavity for positioning items therein. In this disclosure, the header 18 may also be referred to as a sidewall. The vehicle 10 includes an A-pillar region 24A, a B-pillar region 24B, a C-pillar region 24C, and a D-pillar region 24D. The vehicle 10 is a four-door configuration, however other configurations, such as a two-door configuration, may be adapted to incorporate the disclosed concepts. Alternate configurations may include different pillar region references.

The first sidewall 22 and second sidewall 23 are secured to the header 18 at forward box pillar regions of the truck box 14 or the C-pillar regions 24C. The first sidewall 22 and the second sidewall 23 are also secured to the bed 16. The tailgate 20 pivots between an open position and a closed position. In the closed position as shown in FIG. 1, each lateral end of the tailgate 20 may be removably attached to the first sidewall 22 and the second sidewall 23 at respective regions referred to as rear box pillar regions or the D-pillar regions 24D.

FIG. 2 illustrates the truck box 14 and two cable lock assemblies 40 secured thereto. Each of the cable lock assemblies 40 includes a reel assembly 44 and a cable 46. Each of the reel assemblies 44 is mounted to a first standard interface plate (“SIP”) 48 secured to the first sidewall 22. A SIP may also be referred to as a SIP bracket herein. Each of the cables 46 is retractable and extendable. When extended, each of the cables 46 may be secured to one of two second SIPs 52 secured to the second sidewall 23.

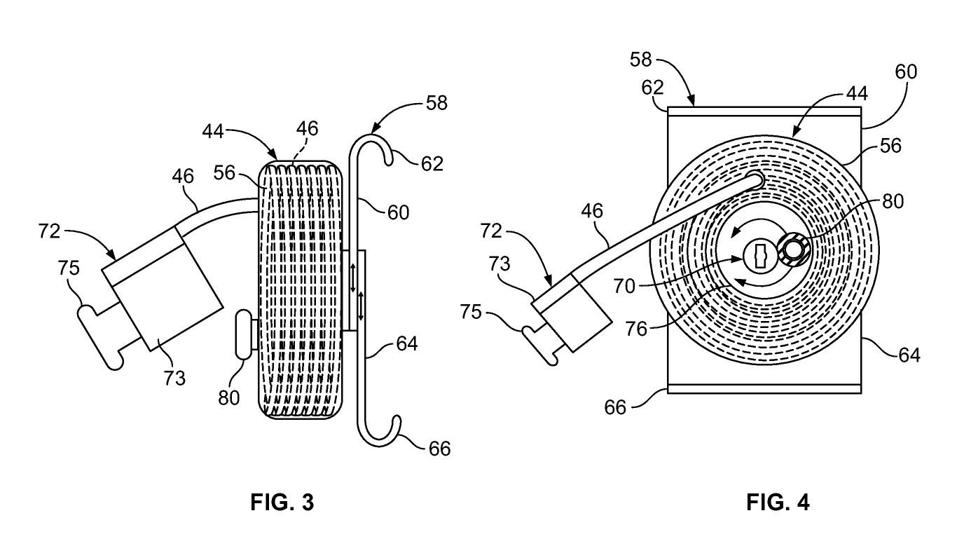

FIGS. 3 and 4 illustrate further details of each of the reel assemblies 44. For example, each of the reel assemblies 44 may include a housing 56 for stowing the cable 46 therein. Each of the housings 56 may be mounted to a base or support structure 58. Each of the support structures 58 may include a first component 60 and a second component 64 slidably mounted to the first component 60 for translation between at least first and second positions.

The support structure 58 may include one or more fasteners for securing to a respective SIP bracket. For example, the first component may have a first hook portion 62 and the second component may have a second hook portion 66. Each of the hook portions may be sized for grasping a respective SIP bracket.

Each of the reel assemblies 44 may further include a first lock mechanism 70 and a second lock mechanism 72. The first lock mechanism 70 may engage or disengage a spool 76 of the reel assembly 44 to allow and prevent spool 76 rotation. For example, the cable 46 may be stowed within the housing 56 and the first lock mechanism 70 may be engaged to prevent removal of the cable 46 from the housing 56. When the first lock mechanism 70 is disengaged, the cable 46 may be extended from within the housing 56. A retraction knob 80 may extend from the spool 76 to rotate the spool 76 based on an engagement position or a disengagement position of the first lock mechanism 70.

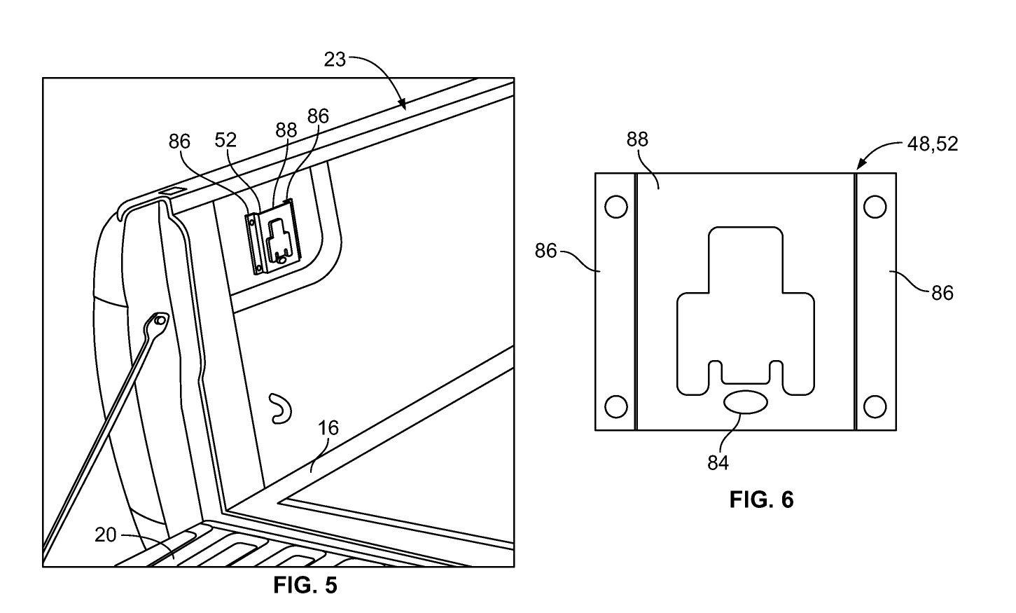

The second lock mechanism 72 may engage or disengage the cable 46 to the second SIP 52. For example, the second lock mechanism 72 may have a tumbler 73 and a cam 75. The tumbler 73 and the cam 75 may be arranged with one another to engage and disengage the cable 46 to the second SIP 52. The cam 75 may be sized to extend through a second SIP aperture 84 (shown in FIGS. 5 and 6) in a first position. The tumbler 73 may be rotated, for example, with a key, to rotate the cam 75 to a second position in which the cam 75 no longer may pass through the second SIP aperture 84 to lock the cable 46 to the second SIP 52.

FIGS. 5 and 6 illustrate further details of each of the cable lock assemblies 40. For example, FIG. 5 illustrates detail of each of the first SIPs 48 and the second SIPs 52. Each of the SIPs includes two base portions 86 for securing to a respective truck box sidewall. Each of the SIPs includes a raised portion 88 extending between the two base portions 86 and includes the second SIP aperture 84. The two base portions 86 and the raised portion 88 are arranged with one another such that the raised portion 88 is spaced from the respective sidewall to provide space for the second lock mechanism 72 to extend therethrough without contacting the respective sidewall. FIG. 6 illustrates one of the second SIPs 52 secured to the second sidewall 23. Each of the first SIPs 48 and the other second SIP 52 may be mounted to a respective sidewall in a similar fashion.

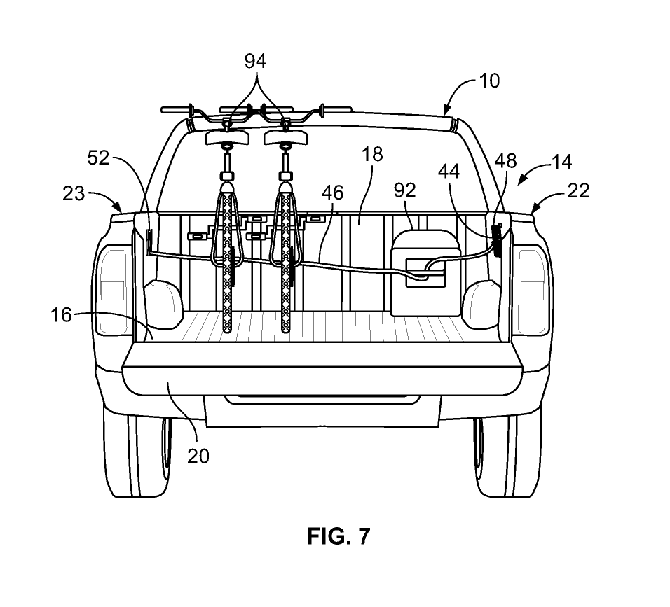

FIG. 7 is a rear view of a portion of the vehicle 10 illustrating items secured within the truck box 14 via the cable lock assembly 40. The cable 46 is shown extending from the cable lock assembly 40 and secured to one of the second SIPs 52. The cable 46 is shown extending through an opening of a cooler 92 and between spokes of two bicycles 94 to retain the cooler 92 and the two bicycles 94 within the truck box 14 to prevent theft thereof.

The embodiments described above are specific examples that do not describe all possible forms of the disclosure. The features of the illustrated embodiments may be combined to form further embodiments of the disclosed concepts. The words used in the specification are words of description rather than limitation. The scope of the following claims is broader than the specifically disclosed embodiments and also includes modifications of the illustrated embodiments.

What is claimed is:

1. A truck box cable assembly comprising:
a first standard interface plate (“SIP”);
a reel assembly including a base for securing to the first SIP, a first lock portion, and a cable wound about a spool for extending and retracting; and
a second SIP located on a truck box wall opposite a location of the first SIP and having a second lock portion to receive the first lock portion to selectively secure the cable.

2. The assembly of claim 1, wherein the base comprises two components slidably mounted to one another to translate between a first position and a second position, each of the two components including a hook portion for grasping the first SIP in the first position for securing the base thereto.

3. The assembly of claim 1, wherein the second SIP includes two base portions for securing to the truck box wall opposite a location of the first SIP and a raised portion extending therebetween such that the raised portion is spaced from the truck box wall to accommodate the first lock portion extending through a second SIP bracket aperture.

4. The assembly of claim 1, wherein the first lock portion and the second lock portion comprise a tumbler and cam arranged with one another to engage and disengage with the second SIP.

5. The assembly of claim 1, wherein the reel assembly further includes a retraction knob arranged with the cable such that rotation of the retraction knob wraps the cable about the spool to stow the cable within a housing of the reel assembly.

6. The assembly of claim 1, wherein the first SIP and the second SIP are arranged with one another for the cable to extend and lock to the second SIP such that the cable may extend through an opening of an item to secure to item within the truck box.

7. The assembly of claim 1, wherein the truck box wall is one of a header and a sidewall.

8. A truck box assembly comprising:
a first sidewall including a first SIP bracket;
a second sidewall opposite the first sidewall and including a second SIP bracket; and
a cable assembly including a support structure for securing to the first SIP bracket, a reel, and a retractable cable for winding and unwinding about the reel, and a lock mechanism for securing the retractable cable to the second SIP bracket.

9. The assembly of claim 8 further comprising a retraction knob extending from the reel to rotate the reel and retract the retractable cable there about, wherein the retraction knob includes a retraction lock to retain the reel in a position.

10. The assembly of claim 8, wherein the support structure includes two plates slidably arranged with one another to translate between a first position and a second position in which the support structure is secured to the first SIP bracket.

11. The assembly of claim 10, wherein each of the two plates includes a hook extending from a respective plate such that each hook grasps the first SIP bracket when the two plates are in the second position.

12. The assembly of claim 8 wherein the lock mechanism comprises a tumbler and cam arranged with one another to engage and disengage the lock mechanism to the second SIP bracket.

13. The assembly of claim 8, wherein the second SIP bracket includes two base portions for securing to the second sidewall and a raised portion extending therebetween such that the raised portion is spaced from the second sidewall to accommodate a lock portion of the lock mechanism extending through a second SIP bracket aperture.

14. The assembly of claim 8, wherein the first SIP bracket and the second SIP bracket are arranged with one another for the retractable cable to extend and lock to the second SIP bracket such that the retractable cable may extend through an opening of an item to secure the item within a truck box at least partially defined by the first sidewall and the second sidewall.

15. A pickup truck box assembly comprising:
a truck box including a bed supporting a first sidewall including a first SIP bracket and a second sidewall including a second SIP bracket; and
a cable assembly having a base for mounting to the first SIP bracket and a retractable cable having a lock mechanism,
wherein the retractable cable is extendable between a first position wound about a reel and a second position in which the lock mechanism is locked to the second SIP bracket.

16. The assembly of claim 15, wherein the second SIP bracket includes two base portions for securing to the second sidewall and a raised portion extending therebetween such that the raised portion is spaced from the second sidewall to accommodate a lock portion of the lock mechanism extending through a second SIP bracket aperture.

17. The assembly of claim 15, wherein the base includes a first component slidably mounted to a second component for translation between first and second positions, and wherein each of the first component and the second components include a hook portion for grasping the first SIP bracket to secure the base to the first SIP bracket in the second position.

18. The assembly of claim 15, wherein the lock mechanism includes a rotatable tumbler and cam sized for insertion within an aperture of the second SIP bracket such that the cam may rotate under key to engage the lock mechanism to the second SIP bracket.

19. The assembly of claim 15, wherein the cable assembly further comprises a retraction knob extending from the reel to rotate the reel and retract the retractable cable there about, wherein the retraction knob includes a retraction lock to retain the reel in a position.

20. The assembly of claim 15, wherein one of the first sidewall and the second sidewall is a header.
